(19) United States
(12) Patent Application Publication
(10) Pub. No.: US 2008/0294525 A1
(43) Pub. Date: Nov. 27, 2008

(54) J2ME application advertisement instrumentation

(76) Inventors: Todd R. Walk, Colorado Springs, CO (US); Nathanael John Bohlmann, Cedar Rapids, IA (US)

Correspondence Address: Todd Walk, 4766 Sand Mountain Point, Colorado Springs, CO, 80923, US

(21) Appl. No.: 12/151,880

(22) Filed: May 9, 2008

Related U.S. Application Data
(60) Provisional application No. 60/931,268, filed on May 22, 2007.

(51) Int. Cl. G06Q 30/00

(52) U.S. Cl. 705/14

(57) ABSTRACT

A method for inserting advertising or other functionality into mobile applications after they have already been compiled and built. The described method has advantages of download time modification of applications, the ability to embed information into the instance builds, and to allow selectable functionality.

### CROSS-REFERENCE TO RELATED APPLICATIONS

This application claims the benefit of provisional patent application Ser. No. 60/931,268, filed 2007 May 22 by the present inventors.

### BACKGROUND

1. Field of Invention

This invention relates to applications running on mobile devices that have software code for advertising inserted into them at a date after they are built for distribution and then having the application in question executed in order to display the advertising.

2. Prior Art

There are 2 other known methods for inserting software code into mobile Java applications after the application is built for distribution.

The first method involves adding a new piece of software code to be started before the original application code and then setting an event to start the original application soon after. This is done by the new piece of code setting a J2ME Java push registry alarm call that executes the original code after a short time interval passes. This method has these downsides: it has a noticeable delay between the added advertising code executing and the original program starting, it is extremely easy to remove the added advertising code, and it's best implementation exploits a J2ME Java virtual machine security flaw which could be removed in the future.

The second method involves decompilation of the J2ME Java program, inserting advertising code into the decompiled output, and then recompiling the code. This method has these disadvantages: some Java obfuscated applications cannot be easily decompiled, decompilation is too slow to be done just before download, and anyone wanting to remove the added advertising code can decompile the code and remove it just like by this method.

Both of these methods have difficulty with embedding download based instance information into the byte code of the builds.

### SUMMARY

A process for embedding advertisements, network based advertisement updaters, or similar material into an already compiled J2ME jar file at download time or earlier and then automatically displaying the advertisement or other material when the mobile device application is started. This also includes the ability to actively select from multiple embedded types and instance information, thereby granting selectable runtime functionality at download time.

### DRAWINGS

### Listings

Listing 1: Javassist instrumentation code.

Listing 2: An example J2ME Java canvas class to be executed by the code added to the application by the Javassist instrumentation code.

### DETAILED DESCRIPTION

### Preferred Embodiment

A basic embodiment of the invention will intercept and redirect an individual downloader's request for a jad file, send information including the jad and jar files to an advertisement server, instrument those files, and then present them to the individual downloader for download. The individual downloader will then execute the application on their mobile device, at which time the advertisement or other instrumented routine will be displayed before the rest of the application is executed.

In more detail, components of the basic embodiment of this invention entail:
1) A jad and jar file for a J2ME Java mobile device application to be hosted on a website server.
2) A redirect to be attached to any access to the jad file to send information/data to the advertisement server.
3) An advertisement server that will take the redirected request along with other information such as, but not limited to, the original jad file, original jar file, the mobile device's make/model, the mobile device's screen size, application title, application description, associated keywords, and the connection to the original download requester.
4) A separate application to instrument the jar file with the code needed to present the advertisement.
5) A compiled and executable Java class file that will be inserted into the jar file and executed by the instrumented code whenever the mobile device application is executed.
6) A version of Sun's Java Development Kit (JDK), a bytecode manipulation tool in Javassist, and Sun's Wireless Tool Kit (for the preverify tool).
7) A displayable advertisement, such as an image file ad, and the tool imagemagik to resize it to fit the mobile device's screen.

### Operation

1) The website server is contacted and a jad file is accessed from it.
2) The jad file access is intercepted and redirected to an advertisement server. During the redirection, the jad file, the mobile device's make/model, the mobile device's screen size, application title, application description, and associated keywords are sent to the advertisement server.
3) The application title, application description, and associated keywords are used to select an advertisement image that fits with the mobile device application.
4) This advertisement image is resized to fit the screen size of the mobile device.
5) The line “MIDlet-Jar-URL:” is found in the jad file and the jar file is then retrieved from this URL.
6) The jar file is extracted into it's own directory by using a standard command line zip file format tool.
7) The line “MIDlet-1: application name, icon name, main MIDlet class name” is found in the jad file, and the third item in the list is saved as the main MIDlet class name.
8) From the extracted jar file contents, the main MIDlet class file is selected from the name attained in step 7. Using a compiled version of Listing 1, run in the same directory that contains the main MIDlet class file: java—Dad.midletName=”main MIDlet class name”—Dad.canvasName=”inserted class name” AdInsert. The Java classpath will need to be set to include the latest midpapi.jar file contained in the Wireless Tool Kit and the rt.jar file contained in the latest Java Development Kit.
9) This creates the new instrumented version of the main MIDlet class. The code inside Listing 1 that is inserted into the beginning of the StartApp method will now be executed first when the application begins. This small piece of added code has one task, which is to load and execute the class code in Listing 2.
10) Preverify from the Wireless Tool Kit is now run on the new main MIDlet class. The Java classpath for preverify must be set to a rt.jar file from a version of the JDK earlier than 1.5. This creates a preverified version of the main MIDlet class into a newly created output directory.
11) Copy the new main MIDlet class out of the output directory to replace the version in the working directory. Delete the output directory.
12) Copy the class to be inserted into the working directory (zzzShowAdCanvas.class from Listing 2).
13) Resize the advertisement image and copy it into the working area.
14) Using a zip compression tool, re-archive the contents of the working directory into a new jar file.
15) Find and change the line “MIDlet-Jar-Size:” in the jad file for the new size of the jar file.
16) Find and change the line “MIDlet-Jar-URL:” in the jad file to point to the new jar file.
17) Return to the individual downloader the new jad file.

The mobile device that originally made the request will then run the newly downloaded mobile device application, the instrumented code inserted will then execute, and the advertisement will be displayed on the user's mobile device before the rest of the application runs.

### Alternative Embodiments

Although the present invention has been described in terms of a basic embodiment, it is not intended that the invention be limited to this embodiment. Many different alternative embodiments should be easily apparent to someone skilled in the art. For example:
1) Same as the originally described embodiment, but instead of inserting an advertisement during instrumentation it will instead have a different inserted class file (a very small modification from Listing 2) that will retrieve the advertisement over the wireless network from an advertisement server.
2) An addition to either the original embodiment or alternative embodiment 1, yet another different inserted class file (another small modification from Listing 2) that would provide animation to the advertisement. This could either be done with some sort of animated image format (such as support for animated GIFs or MPEG video) or by having the inserted class file be custom developed for the animation.
3) A major additional embodiment is instead of hard coding what sort of class file is inserted for additional functionality (Listing 2 and additional embodiments 1 & 2), to dynamically select one of several variants depending on the type of advertisements, ad campaign type, or from what the originally contacted server would specify.
4) To reduce the amount of bandwidth consumed by communication between the originally contacted server and the advertisement server, the originally contacted server could instead have the updated jad and jar files sent to it, cache them, and then send the new versions directly to the individual downloader. It could then retrieve the cached version for any number of times and return that version to individual downloaders instead of having a new jad and jar file version updated each and every time.

### Advantages

There are several advantages to the previous technologies. A key advantage is since the actual instrumentation of the advertising code is done quickly by working directly on the bytecode, custom modifications can be done for every single download to a mobile device. This allows customization of the added code for the individual downloader. It also allows markers to be placed inside the bytecode of the application itself for a number of possible reasons, such as preventing advertising fraud or to make the added code more difficult to remove. This also gives a method that is immune to issues of bypassing the J2ME Java security model and the problems with decompiling the original application. Another key advantage is the ability to add advertising code to applications that will not normally decompile at all (because of obfuscation or other reasons).

### CONCLUSION, RAMIFICATIONS, AND SCOPE

Accordingly, the reader will see that the basic embodiment allows the insertion of advertising code into already compiled and built J2ME Java applications in such a way that advertising insertion can be delayed until just before the actual application download to the mobile device occurs.

Although the description above contains many specificities, these should not be construed as limiting the scope of the embodiment but as merely providing illustrations of some of the presently preferred embodiments. For example, the tool used for directly modifying the bytecode of the application could be any tool capable of the same operations. Also other bytecode based mobile application platforms could also be handled besides the J2ME Java platform if a correct bytecode manipulation tool exists.

Thus the scope of the embodiment should be determined by the appended claims and their legal equivalents, rather than by the examples given.

LISTING 1

```
import javax.microedition.midlet.*;
import javax.microedition.lcdui.*;
import java.lang.*;
import java.io.*;
import java.util.*;
import java.io.IOException;
import javassist.*;
public class AdInsert {
  public static void main(String[ ] args) throws Exception {
  ClassPool pool = ClassPool.getDefault( );
  String midletName=java.lang.System.getProperty(“ad.midletName”,“”);
  CtClass cc = pool.get(midletName);
  String canvasName=
  java.lang.System.getProperty(“ad.canvasName”,“”);
  CtClass cc2 = pool.get(canvasName);
  try {
    //Add the field to check if we've displayed the ad or not
    //(In J2ME, startApp can be called multiple times)
    cc.addField(new CtField(CtClass.intType,“_zzzInitializeAd”,cc),
      CtField.Initializer.constant(0));
    CtMethod startAppMethod = cc.getDeclaredMethod(“startApp”);
    startAppMethod.insertBefore(
      “if(_zzzInitializeAd==0) {” +
      “ ”+canvasName+“ canvas=new ”+canvasName+“( );” +
      “ canvas.start(this);” +
      “ canvas=null;” +
      “ System.gc( );” +
      “ _zzzInitializeAd=0;” +
      “ }”);
    cc.writeFile( );  // update the class file
    System.out.println(“Updated.”);
  }
  catch (CannotCompileException e) {
    System.out.println(“CannotCompileException.”);
  }
  catch (NotFoundException e) {
    System.out.println(“NotFoundException.”);
  }
  }
}
```

LISTING 2

```
import javax.microedition.lcdui.*;
import javax.microedition.midlet.*;
import javax.microedition.lcdui.game.*;
import java.lang.*;
import java.io.*;
import java.util.*;
public class zzzShowAdCanvas extends GameCanvas {
  public zzzShowAdCanvas( ) {
    super(false);
  }
  public void start(MIDlet mid) {
    Display d=Display.getDisplay(mid);
    d.setCurrent(this);
    Graphics g=getGraphics( );
    setFullScreenMode(true);
    g.setColor(0,0,0);
    int w=getWidth( );
    int h=getHeight( );
    int xOffset=0;
    int yOffset=0;
    Image[ ] img;
    img=new Image[4];
    for(int i=0;i<4;i++) img[i]=null;
    try {
      img[0]=Image.createImage(“/zzzAd1.jpg”);
    }
    catch(IOException ioe) { }
    try {
      img[1]=Image.createImage(“/zzzAd2.jpg”);
    }
    catch(IOException ioe) { }
    try {
      img[2]=Image.createImage(“/zzzAd3.jpg”);
    }
    catch(IOException ioe) { }
    try {
      img[3]=Image.createImage(“/zzzAd4.jpg”);
    }
    catch(IOException ioe) { }
    //find the offsets
    xOffset=(w−img[0].getWidth( ))/2;
    if(xOffset<0) xOffset=0;
    if(img[1]==null) //this is either small or medium
    {
      yOffset=(h−img[0].getHeight( ))/2;
      g.fillRect(0,0,(w>128)?w:128,(h>160)?h:160);
    }
    else if(img[3]==null) //this is large
    {
      yOffset=(h−img[0].getHeight( )*2)/2;
      g.fillRect(0,0,(w>176)?w:176,(h>220)?h:220);
    }
    else //must be huge
    {
      yOffset=(h−img[0].getHeight( )*4)/2;
      g.fillRect(0,0,(w>240)?w:240,(h>320)?h:320);
    }
    if(yOffset<0) yOffset=0;
    if(img[0]!=null)
    g.drawImage(img[0].xOffset,yOffset,Graphics.LEFT|Graphics.TOP);
    if(img[1]!=null) g.drawImage(img[1],xOffset,(img[3]!=null)?
      (yOffset+img[0].getHeight( )):(h/
      2),Graphics.LEFT|Graphics.TOP);
    if(img[2]!=null)
    g.drawImage(img[2],xOffset,h/2,Graphics.LEFT|Graphics.TOP);
    if(img[3]!=null) g.drawImage(img[3],xOffset,h/
    2+img[2].getHeight( ),
      Graphics.LEFT|Graphics.TOP);
    flushGraphics( );
    for(int i=0;i<4;i++) img[i]=null;
    try {
      Thread.sleep(2000);
    }
    catch(java.lang.InterruptedException e) { }
  }
}
```

We claim:

1. A method of inserting an advertisement into a previously built mobile device application on a mobile device, comprising:
(a) providing said previously built mobile device application to be modified to display said advertisement when run on said mobile device,
(b) providing said advertisement for display selected from the group consisting of advertisements supplied previous to insertion and advertisements supplied by later network access by the application,
(c) providing an executable advertising code for insertion into the application for displaying said advertisement, and
(d) bytecode manipulation means for inserting said executable advertising code into the starting point of the application by direct bytecode modification,
whereby said advertisement will be quickly inserted into said previously built mobile device application for later display.

2. The method of claim 1, further including one or more of a separately contained executable code piece that is called from said executable advertising code,
whereby the one or more separately contained executable code pieces can be used to extend the functionality of the inserted advertising code and to allow replaceable and selectable modules for custom functionality,

3. A method of inserting an executable advertising code into a previously built mobile device application during the process of downloading the application into a mobile device, comprising:
(a) providing said previously built mobile device application to be modified to display an advertisement when run on said mobile device,
(b) providing a server to be accessed by said mobile device that contains the application,
(c) providing said mobile device for accessing the application from said server, and
(d) advertising code insertion means for direct insertion of said executable advertising code during the application download,
whereby said previously built mobile device application has said executable advertising code inserted into it during the download process.
